(19) United States
(12) Patent Application Publication
(10) Pub. No.: US 2019/0220841 A1
(43) Pub. Date: Jul. 18, 2019

(54) DYNAMIC MICROPAYMENT FEE SELECTOR

(71) Applicant: Wells Fargo Bank, N.A., San Francisco, CA (US)

(72) Inventors: Wayne Barakat, Novato, CA (US); Nathan Craig Bricklin, Walnut Creek, CA (US); Kristine Ing Kushner, Orinda, CA (US); Yung Ung Lee, Oakley, CA (US); Andrea Renee Leighton, San Francisco, CA (US); Orsolya Oldroyd, Walnut Creek, CA (US); Wairnola Marria Rhodriquez, San Francisco, CA (US); Paul Vittimberga, Oakland, CA (US); Ronald H. Yang, El Cerrito, CA (US)

(21) Appl. No.: 15/870,045

(22) Filed: Jan. 12, 2018

(51) Int. Cl. G06Q 20/22; G06Q 20/10

(52) U.S. Cl. CPC G06Q 20/29; G06F 3/0482; G06Q 20/10

(57) ABSTRACT

Systems and techniques for dynamic micropayment fee selector are described herein. A transaction stream may be obtained from an electronic transaction processing service. A transaction velocity of a set of transactions that correspond to a user account of the electronic transaction processing service included in the transaction stream may be calculated for a first period of time. A fee tier data structure may be generated based on the transaction velocity. A fee tier of the fee tier data structure may be applied to the user account. An indication of the applied fee tier and an electronic representation of the fee tier data structure may be transmitted to a device associated with the user account.

### TECHNICAL FIELD

Embodiments described herein generally relate to transaction fee selection and, in some embodiments, more specifically to dynamic selection of transaction processing fees based on transaction velocity.

### BACKGROUND

Micropayments may describe payments for goods or services in small sums (e.g., less than one dollar, etc.). Micropayments may be used in electronic transactions. The transaction processing fee for a micropayment may, in some instances, be greater than the amount of the micropayment itself. Charging a micropayment amount for a good or service may result in a high volume of transactions.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 is a block diagram of an example of an environment and a system for dynamic micropayment fee selector, according to an embodiment.

FIG. 2 illustrates a flow diagram of an example of a process for dynamic micropayment fee selector, according to an embodiment.

FIG. 3 illustrates an example of a user interface for dynamic micropayment fee selector, according to an embodiment.

FIG. 4 illustrates an example of a method for dynamic micropayment fee selector, according to an embodiment.

FIG. 5 is a block diagram illustrating an example of a machine upon which one or more embodiments may be implemented.

### DETAILED DESCRIPTION

An electronic transaction processing service may process transactions between a customer and vendor. For example, a customer may pay for a book from an online bookseller using a credit card and the electronic transaction processing service may facilitate transfer of funds from the credit card of the customer to the bookseller. The electronic transaction processing service may traditionally charge a fee for providing this service. In some instances, a base fee may be charged per transaction in combination with a variable (e.g., a percentage, etc.) amount of the transaction.

Micro-payments may be very small and traditional transaction fees may be higher than the micro-payment itself. For example, a customer may purchase a page of a book for fifteen cents from the bookseller using a credit card and the electronic transaction processing service may charge a transaction fee of twenty cents plus three percent of the total transaction amount. In the example, the bookseller may actually lose money by completing the transaction. As a result, some products and services may not be offered because each transaction may result in a loss for the merchant. Reducing the fees may result in a reduction in transaction processing losses for the merchant which may result in the offering of additional products and services (e.g., those involving micro-payments).

The techniques and systems discussed herein may provide for automatic adjustment of micro-payment fee schedules based on, for example, a transaction velocity (e.g., the volume of transactions for a time period, etc.) of a customer. The transaction fees may be lowered as transactions increase over a period of time. In an example, fees may be adjusted lower while customer service features may be reduced. For example, a customer may have been earning points for processed transactions and points may no longer accrue after a transaction fee is reduced, etc. A fee tier data structure may be generated and customized based on transaction history of the customer and may take other customer activity (e.g., revenue streams, other relationships with the processor, etc.) into consideration. The model may include a fee threshold determined based on the processor's processing costs and revenue that may be expected from other customer activity.

Transaction velocity of a merchant may be evaluated to determine a fee structure for a period of time. A higher transaction velocity may result in a lower fee per transaction. Traditional fee structures for non-micropayments may be retained (e.g., for non-micropayment transactions, etc.). There may be a variety of collection models for fee shifting among the merchant, bank, and a customer of a bank that transacts with a merchant. A merchant may enroll in a program. An initial micro-payment with a merchant may be an authorization and processing of the transaction may be completed at a later time to allow for additional micro-payments which may then be processed as a single transaction. In an example, micro-payments may be aggregated and processed in bulk. In another example, micro-payments from customers using the processing bank for payment may be aggregated and processed as a group. The customer may be provided with a set of pricing tiers and may select an initial tier and after transaction velocity is determined they may be automatically moved to a different tier. The system may detect micro-payment patterns for customers and may automatically recommend a subscription plan for the customer incentivizing a transition from micro-payments to traditional payment. The system may track seasonal changes in transaction velocity and may identify event triggers that increase spending that may be provided to the merchant to help them remain in a particular fee tier. The system may also evaluate customer spending patterns and costs so that the merchant may determine which customers result in positive return on investment. Content creation expense may be taken into account in determining cost of services and consumption expectations.

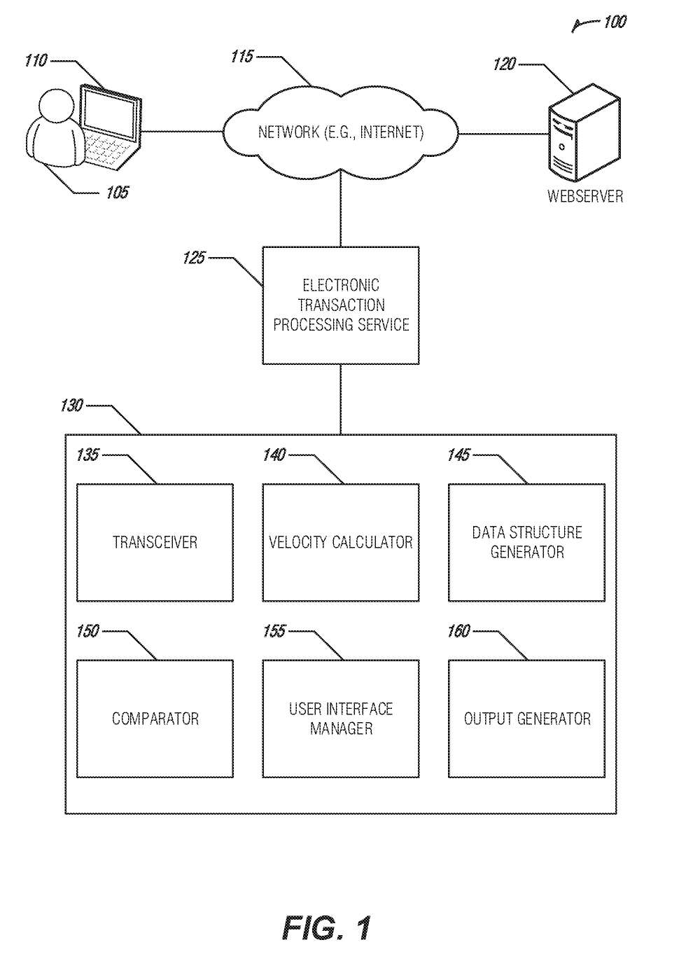

FIG. 1 is a block diagram of an example of an environment 100 and a system 130 for dynamic micropayment fee selector, according to an embodiment. The environment 100 may include a customer 105 (e.g., a payee of a transaction, etc.) that may use a computing device 110 (e.g., smartphone, tablet, laptop computer, desktop computer, etc.) to interact over a network 115 (e.g., the internet, etc.) with a webserver 120 (e.g., an electronic store front, web-based service provider, etc.) of an entity providing products or services in exchange for payment. The webserver 120 may be communicatively coupled (e.g., via a wired network, wireless network, the internet, shared bus, etc.) to an electronic transaction processing service 125 for processing transactions of the customer 105. For example, the customer 105 may subscribe to an electronic newsletter provided by the entity corresponding with the webserver 120 and the transaction may be processed by the electronic transaction processing service 125.

The electronic transaction processing service 125 may be communicatively coupled to the system 130. The system 130 may provide dynamic micropayment fee selection for the electronic transaction processing service 125. The system may include a variety of components such as a transceiver 135, a velocity calculator 140, a data structure generator 145, a comparator 150, a user interface manager 155, and an output generator 160.

The transceiver 135 may process input received by and output to be transmitted by the system 130. The transceiver 135 may obtain a transaction stream from the electronic transaction processing service 125. For example, the entity providing the webserver 120 may have a user account with the electronic transaction processing service 125. Transactions between the webserver 120 and the computing device 110 may be processed by the electronic transaction processing service 125. For example, a purchase of the customer 105 of an electronic document from the webserver 120 may cause the electronic transaction processing service 125 to make a charge against a payment account (e.g., credit card, bank account, etc.) of the user 105. The charge may be credited, by the electronic transaction processing service 125 to the user account of the entity providing the webserver 120.

The transaction records may be stored (e.g., in a transaction log, etc.). Transactions occurring during a certain period (e.g., hours, days, weeks, months, etc.) may be considered a transaction stream for the period. The transaction stream may include data regarding the transactions such as, for example, date of transaction, time of transaction, location of transaction, amount of transaction, description of a product or service included in the transaction, etc.

The velocity calculator 140 may calculate a transaction velocity of a set of transactions corresponding to a user account of the electronic transaction processing service 125. The transaction velocity may indicate a transaction volume for the user account of the first period of time. For example, the first period of time may run from the current date and time back seven days and the transaction velocity may include the volume of transactions for the period. For example, there may have been 1,000,000 transactions processed in the period as determined by summing all transactions occurring during the time period.

In an example, the first time period may be subdivided into components (e.g., days, hours, minutes, etc.) and a transaction volume may be calculated for each subdivision. The transaction velocity may be identified for the time period by identifying increasing (or decreasing) transaction volume across the subdivisions. For example, an evaluation of the subdivisions may indicate that transaction volume is increasing as transaction time approaches the current date and time.

In an example, a transaction trend may be determined over a period of time from transaction history data for the user account. This period of time may be the same as or different than the first period of time. The transaction trend may indicate a period of peak transaction velocity. For example, the transaction history data may include transactions completed over the past eighteen months and a period of peak transaction velocity may be identified for the year. For example, the month of November may be identified as a period of peak transaction velocity for an entity providing holiday greeting messages. The first period of time may be identified in the transaction stream as a period of time in the transaction stream corresponding to the transaction trend in the second period of time. For example, the first period of time may be identified as November. This may allow for fee tiers to be established on a seasonal basis based on past transaction history.

The data structure generator 145 may generate a fee tier data structure based on the transaction velocity. The fee tier data structure may include relationships between transaction processing fees and corresponding criteria for fee selection. The fee tier data structure may include one or more rules for fee selection. For example, a fee may have a rule related to criteria for a transaction velocity level and/or activities by an entity corresponding to the user account (e.g., other account opening, interest payments, investment activity, activity in other accounts of the entity, etc.). A rule for the fee may indicate that the fee may be selected if two of the criteria are achieved. For example, the user account of a merchant or customer may have a transaction velocity of 1,000,000 and may have a business line of credit which may match criteria for a fee comprising five cents plus one percent of the total transaction amount transaction fee included in the fee data structure. The fee may be selected based on a rule indicating that the fee may be selected if two of the criteria are met. The fee tier data structure may include a variety of increasing and decreasing fees based on the calculated transaction velocity.

In an example, an activity history may be identified for the user account. The activity history may include activities by an entity corresponding to the user account outside the electronic transaction processing service. For example, the activities may include opening a business line of credit. The fee tier data structure may be generated in part using data included in the activity history. For example, the entity may have a variety of other user accounts open with an organization providing the electronic transaction processing service 125 and the fee tier data structure may be generated based on entity having an open business line of credit. The fee tier data structure may be generated based on current transaction velocity and criteria of the entity corresponding to the user account. The fee tier data structure may be generated with levels representing the addition (or deletion) of activities (e.g., account opening/closing, payment history, account balance, etc.).

In some examples, the transaction fee may be passed on to the customer 105 and the customer may be presented with a user interface for reducing the transaction fee or recommending other purchases to raise the cost of the purchase above the transaction fee. In an example, the customer 105 may be presented with a user interface including a set of generated user interface elements representing activities (e.g., purchases, etc.) that may be completed by the customer 105. The customer 105 may select one or more of the activities and the transaction fee may be lowered or the purchase total may increase above the transaction fee. For example, the customer 105 may be purchasing a few pages from a document and the customer 105 may be provided with additional related content that may be of interest to the customer 105. The transaction fee may then be lowered or the customer 105 may be presented with an indication that the purchase total is now above the transaction fee. In an example, the customer 105 may be presented with a user interface that provides subscription, credit options, etc. that may provide the customer 105 a way to reduce transaction fees with the webserver 120.

In an example, a set transactions may be identified in the transaction stream corresponding to a payee (e.g., the customer 105, etc.) and a total transaction value may be calculated for the set of transactions. The fee tier data structure may be generated by evaluating the total transaction value. For example, the transactions for the customer 105 may be aggregated over the first time period and the total value of the transactions may be used as a criteria in generating the fee tier data structure. In an example, transactions by a group of payees (e.g., all, those having the top 100 transaction counts, etc.) may be aggregated for each payee and averaged and the average may be used as a criteria in generating the fee tier data structure.

The comparator 150 may apply a fee tier of the fee tier data structure to a transaction processing account of the user account. The fee tier application may be based on a selection of the fee tier from the fee tier data structure based on the current transaction velocity of the user account. The comparator 150 may continually (or periodically) apply a fee tier as the transaction velocity or other criteria is achieved.

The comparator 150 may identify a set of features (e.g., fraud protection options, customer service options, etc.) applied to the user account. The comparator 150 may select a feature from the set of features based on the applied fee tier. The fee tier data structure may include rules for which user account features may be applied to user accounts to which a fee tier is applied. For example, a fee tier including a transaction fee of five cents plus one percent of the total transaction may not have chargeback protection (e.g., paying for charges reversed by the customer 105 for a transaction completed on the webserver 120, etc.) applied. The selected feature may be removed from the set of features. For example, the fee tier including a transaction fee of five cents plus one percent of the total transaction may prompt the automatic removal of the chargeback protection feature.

The user interface manager 155 may work in conjunction with the output generator 160 to generate and display user interfaces to a user (e.g., an employee of the entity providing the webserver 120, etc.) of the system 130. The user interfaces may provide the user with configuration options for the user account and may provide the user with options for adjusting transaction processing fees.

In an example, the user interface manager 155 may present a user interface to a display device and may generate an editable maximum tier user interface option for display in the user interface. The user interface manager 155 may identify a modification to the editable maximum tier user interface element. The modification may represent a maximum fee tier. For example, the user may be presented with a user interface including a dropdown box including a variety of fee tiers (e.g., fee ranges, etc.) and text indicating that transactions will not be processed above the selected fee tier. The user may select a fee tier from the drop down box and the selection may be identified add the maximum fee tier for the user account. The comparator 150 may then evaluate the selected fee tier against the maximum fee tier to determine if the selected fee tier is above the maximum fee tier. If so, transaction processing may be prevented for the user account. If not, the fee tier may be applied and transactions may continue to be processed. Thus, the user may be able to prevent unexpected transaction fees.

In another example, a user interface may be presented to a device of the user and a plurality of user interface elements may be generated for display in the user interface. The user interface elements may represent activities to be completed. For example, the user interface elements may include elements for opening a business line of credit, opening a mortgage, refinancing a mortgage, completing a fraud reduction computer-based training session, etc. The user may select one or more user interface elements indicating activities that may be completed. A selection of the one or more user interface elements may be received and an activity matrix may be generated based on the selection. The activity matrix may include a variety of steps to be completed for each activity leading to completion. Completion of the activities may be identified that correspond to the activity matrix and the fee tier data structure may be modified based on the completion of the activities. For example, the user may be presented with a current fee tier and completion of one or more of the activities may cause the fee tier data to be modified and a new fee tier to be presented.

In an example, selection of the user interface elements may cause a new temporary fee tier data structure to be generated based on the fee tier data structure. The temporary fee tier data structure may then be modified based on the selected user interface elements resulting in the presentation of an estimated fee tier selection. This may allow the user to model different combinations of activities to determine their effects on the fee tier of the user account.

In another example, an activity roadmap may be generated for an entity corresponding to the user account and the activity roadmap may be presented in a user interface. The completion of an activity may be identified that corresponds to the activity roadmap and the fee tier data structure may be modified based on the completion of the activity. For example, the user may be presented with a variety of activities that may result in lower transaction fees at the current transaction velocity level. The user may complete the activities on behalf of the entity and the fee tier data structure may be modified and a new fee tier may be selected. In an example, the activities may correspond to criteria for fee tiers included in the fee tier data structure and may be presented based on the rules in the fee tier data structure indicating that completion of the activity would allow selection of a fee tier.

The output generator 160 may work in conjunction with the user interface manager 155 and the transceiver 135 to transmit an indication of the applied fee tier and an electronic representation of the fee tier data structure to a device of a user corresponding with the user account. For example, the indication may be presented in a user interface and may display the currently applied fee tier and the fee tier data structure. In an example, the currently applied fee tier may be highlighted in the representation of the fee tier data structure. In an example, the graphical representation of the fee tier data structure may include an indication of criteria such as, for example, a transaction velocity, activity, etc. that may be achieve to select a different fee tier.

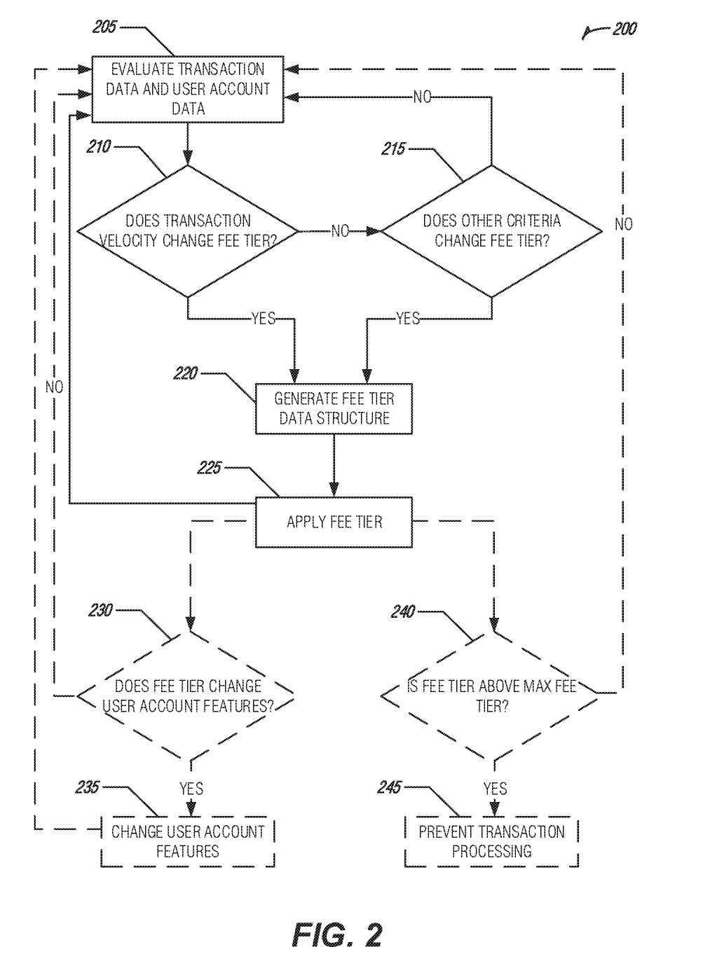

FIG. 2 illustrates a flow diagram of an example of a process 200 for dynamic micropayment fee selector, according to an embodiment. The process 200 may provide features as described in FIG. 1.

Transaction and user account data of a user account (e.g., a customer of the bank or a merchant) may be evaluated (e.g., by the comparator 150 as described in FIG. 1, etc.) to calculate a transaction velocity (e.g., by the velocity calculator 140 as described in FIG. 1, etc.) for a period of time and user account criteria (e.g., other accounts, user activity, etc.) at operation 205. The data may be evaluated to determine if the calculated transaction velocity changes the fee tier at decision 210. If not, the criteria may be evaluated to see if they change the fee tier at decision 215. If the transaction velocity and the criteria do not change the fee tier, the transaction data and user account data may continue to be monitored at operation 205.

If the transaction velocity or the criteria change the fee tier a data structure may be generated based on the transaction velocity and the criteria (e.g., by the data structure generator 145 as described in FIG. 1, etc.). A new fee tier of the generated fee tier data structure may be applied at operation 225. The transaction data and user account data may continue to be monitored at operation 205. Thus, changes may be made dynamically as the transaction velocity and criteria change.

In an example, it may be determined whether the applied fee tier changes user account features at decision 230. In other words, it may be determined whether the new fee tier is compatible or incompatible with features available for the user account. If the fee tier has an impact on features, the features may be changed for the user account at operation 235. For example, a previously disabled feature may be enabled for the user account or a currently enabled feature may be disabled for the user account. The transaction data and user account data may continue to be monitored at operation 205.

In another example, it may be determined whether the applied fee tier is above a maximum fee tier setting for the user account at decision 240. If it is determined that the applied fee tier is above the fee maximum, transaction processing may be disabled for the user account at operation 245. If the applied fee tier is below the maximum, the transaction data and user account data may continue to be monitored at operation 205.

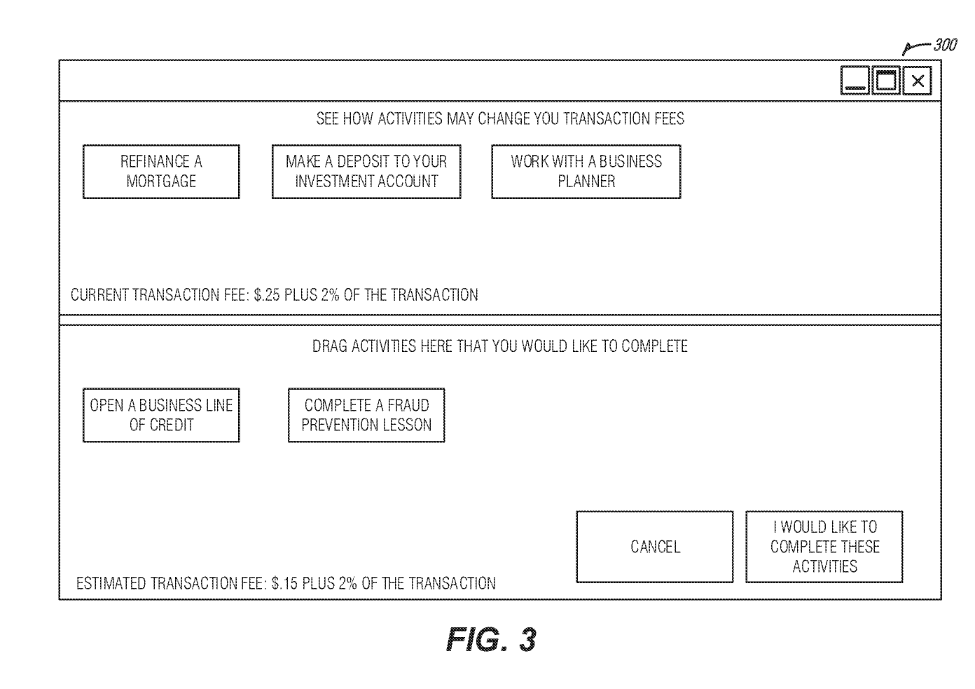

FIG. 3 illustrates an example of a user interface 300 for dynamic micropayment fee selector, according to an embodiment. The user interface 300 may provide features as described in FIGS. 1 and 2.

The user interface 300 shows user interface elements representing activities that may be completed by a user such as a bank customer to adjust transaction fees. The user may drag and drop available activity user interface elements to a window to select activities that the user may be interested in completing. The estimated transaction fee tier may be displayed based on a data structure model including the activities as criteria. The user may choose to submit the desired activities as activities that the user intends to complete. The fee tier data structure may be modified (or regenerated) as the user completes the activities. A new fee tier may be applied as activities are completed based on the criteria included in the fee tier data structure and the transaction velocity at the time of the change.

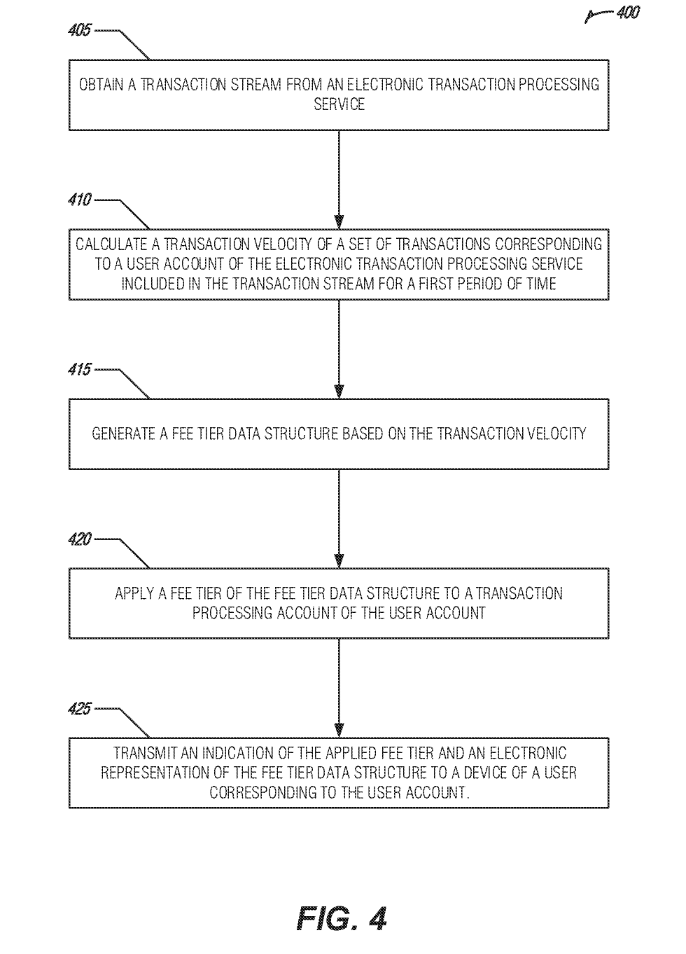

FIG. 4 illustrates an example of a method 400 for dynamic micropayment fee selector, according to an embodiment. The method 400 may provide features as described in FIGS. 1-3.

A transaction stream may be obtained (e.g., by the transceiver 135 as described in FIG. 1, etc.) from an electronic transaction processing service (e.g., at operation 405). A transaction velocity may be calculated (e.g., by the velocity calculator 135 as described in FIG. 1, etc.) for a set of transactions corresponding to a user account of the electronic transaction processing service included in the transaction stream for a first period of time (e.g., at operation 410). In an example, a transaction trend may be determined over a second time period from transaction history data for the user account. The transaction trend may indicate a period of peak transaction velocity. The first period of time may be identified as a period of time in the transaction stream corresponding to the transaction trend in the second period of time.

A fee tier data structure may be generated (e.g., by the data structure generator 145 as described in FIG. 1, etc.) based on the transaction velocity (e.g., at operation 415). In an example, an activity history may be identified for the user account. The activity history may include activities by an entity (e.g., merchant or customer) that corresponds to the user account outside the electronic transaction processing service. The fee tier data structure may be generated in part using data included in the activity history. In an example, a set of transactions may be identified in the transaction stream corresponding to a payee and a total transaction value may be calculated for the set of transactions. Generating the fee tier data structure may include evaluating the total transaction value.

A fee tier of the fee tier data structure may be applied (e.g., by the comparator 150 as described in FIG. 1, etc.) to a transaction processing account of the user account (e.g., at operation 420). An indication of the applied fee tier and an electronic representation of the fee tier data structure may be transmitted (e.g., by the output generator 160 and the transceiver 150 as described in FIG. 1, etc.) to a device of a user corresponding to the user account (e.g., at operation 425).

In an example, a user interface may be presented (e.g., by the user interface manager 155 as described in FIG. 1, etc.) to a display device. A plurality of user interface elements may be generated for display in the user interface. A selection of one or more of the plurality of the user interface elements may be received and an activity matrix may be generated based on the selection. Completion of the activities corresponding to the activity matrix may be identified and the fee tier data structure may be modified based on the completion of the activities.

In another example, an activity roadmap may be generated for an entity corresponding to the user account and the activity roadmap may be presented in a user interface. Completion of an activity corresponding to the activity roadmap may be identified and the fee tier data structure may be modified based on the completion of the activity.

In yet another example, a user interface may be presented in a display device. An editable maximum tier user interface element may be generated for display in the user interface and a modification to the editable maximum tier user interface element may be identified. It may be determined that the fee tier is above the maximum fee tier and transaction processing may be prevented for the user account.

In an example, a set of features applied to the user account may be identified. A feature of the set of features may be selected based on the fee tier and the feature may be removed from the set of features.

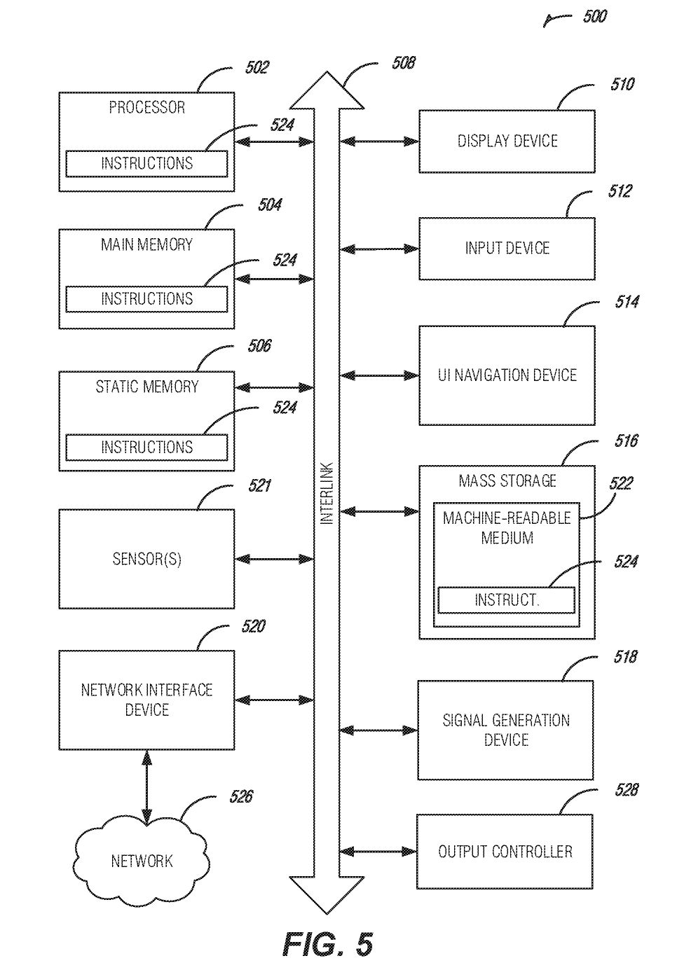

FIG. 5 illustrates a block diagram of an example machine 500 upon which any one or more of the techniques (e.g., methodologies) discussed herein may perform. In alternative embodiments, the machine 500 may operate as a standalone device or may be connected (e.g., networked) to other machines. In a networked deployment, the machine 500 may operate in the capacity of a server machine, a client machine, or both in server-client network environments. In an example, the machine 500 may act as a peer machine in peer-to-peer (P2P) (or other distributed) network environment. The machine 500 may be a personal computer (PC), a tablet PC, a set-top box (STB), a personal digital assistant (PDA), a mobile telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

Examples, as described herein, may include, or may operate by, logic or a number of components, or mechanisms. Circuit sets are a collection of circuits implemented in tangible entities that include hardware (e.g., simple circuits, gates, logic, etc.). Circuit set membership may be flexible over time and underlying hardware variability. Circuit sets include members that may, alone or in combination, perform specified operations when operating. In an example, hardware of the circuit set may be immutably designed to carry out a specific operation (e.g., hardwired). In an example, the hardware of the circuit set may include variably connected physical components (e.g., execution units, transistors, simple circuits, etc.) including a computer readable medium physically modified (e.g., magnetically, electrically, moveable placement of invariant massed particles, etc.) to encode instructions of the specific operation. In connecting the physical components, the underlying electrical properties of a hardware constituent are changed, for example, from an insulator to a conductor or vice versa. The instructions enable embedded hardware (e.g., the execution units or a loading mechanism) to create members of the circuit set in hardware via the variable connections to carry out portions of the specific operation when in operation. Accordingly, the computer readable medium is communicatively coupled to the other components of the circuit set member when the device is operating. In an example, any of the physical components may be used in more than one member of more than one circuit set. For example, under operation, execution units may be used in a first circuit of a first circuit set at one point in time and reused by a second circuit in the first circuit set, or by a third circuit in a second circuit set at a different time.

Machine (e.g., computer system) 500 may include a hardware processor 502 (e.g., a central processing unit (CPU), a graphics processing unit (GPU), a hardware processor core, or any combination thereof), a main memory 504 and a static memory 506, some or all of which may communicate with each other via an interlink (e.g., bus) 508. The machine 500 may further include a display unit 510, an alphanumeric input device 512 (e.g., a keyboard), and a user interface (UI) navigation device 514 (e.g., a mouse). In an example, the display unit 510, input device 512 and UI navigation device 514 may be a touch screen display. The machine 500 may additionally include a storage device (e.g., drive unit) 516, a signal generation device 518 (e.g., a speaker), a network interface device 520, and one or more sensors 521, such as a global positioning system (GPS) sensor, compass, accelerometer, or other sensor. The machine 500 may include an output controller 528, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The storage device 516 may include a machine readable medium 522 on which is stored one or more sets of data structures or instructions 524 (e.g., software) embodying or utilized by any one or more of the techniques or functions described herein. The instructions 524 may also reside, completely or at least partially, within the main memory 504, within static memory 506, or within the hardware processor 502 during execution thereof by the machine 500. In an example, one or any combination of the hardware processor 502, the main memory 504, the static memory 506, or the storage device 516 may constitute machine readable media.

While the machine readable medium 522 is illustrated as a single medium, the term “machine readable medium” may include a single medium or multiple media (e.g., a centralized or distributed database, and/or associated caches and servers) configured to store the one or more instructions 524.

The term “machine readable medium” may include any medium that is capable of storing, encoding, or carrying instructions for execution by the machine 500 and that cause the machine 500 to perform any one or more of the techniques of the present disclosure, or that is capable of storing, encoding or carrying data structures used by or associated with such instructions. Non-limiting machine readable medium examples may include solid-state memories, and optical and magnetic media. In an example, a massed machine readable medium comprises a machine readable medium with a plurality of particles having invariant (e.g., rest) mass. Accordingly, massed machine-readable media are not transitory propagating signals. Specific examples of massed machine readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; and CD-ROM and DVD-ROM disks.

The instructions 524 may further be transmitted or received over a communications network 526 using a transmission medium via the network interface device 520 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, peer-to-peer (P2P) networks, among others. In an example, the network interface device 520 may include one or more physical jacks (e.g., Ethernet, coaxial, or phone jacks) or one or more antennas to connect to the communications network 526. In an example, the network interface device 520 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding or carrying instructions for execution by the machine 500, and includes digital or analog communications signals or other intangible medium to facilitate communication of such software.

### Additional Notes

The above detailed description includes references to the accompanying drawings, which form a part of the detailed description. The drawings show, by way of illustration, specific embodiments that may be practiced. These embodiments are also referred to herein as “examples.” Such examples may include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

All publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The above description is intended to be illustrative, and not restrictive. For example, the above-described examples (or one or more aspects thereof) may be used in combination with each other. Other embodiments may be used, such as by one of ordinary skill in the art upon reviewing the above description. The Abstract is to allow the reader to quickly ascertain the nature of the technical disclosure and is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description, with each claim standing on its own as a separate embodiment. The scope of the embodiments should be determined with reference to the appended claims, along with the full scope of equivalents to which such claims are entitled.

What is claimed is:

1. A system for dynamic micropayment fee selection, the system comprising:
at least one processor; and
memory including instructions that, when executed by the at least one processor, cause the at least one processor to perform operations to:
obtain a transaction stream from an electronic transaction processing service;
calculate a transaction velocity of a set of transactions that corresponds to a user account of the electronic transaction processing service included in the transaction stream for a first period of time;
generate a fee tier data structure based on the transaction velocity;
apply a fee tier of the fee tier data structure to the user account; and
transmit, to a device associated with the user account, an indication of the applied fee tier and an electronic representation of the fee tier data structure.

2. The system of claim 1, further comprising instructions to:
identify an activity history for the user account, wherein the activity history includes activities by an entity that corresponds to the user account outside the electronic transaction processing service, and wherein the instructions to generate the fee tier data structure include instructions to use data included in the activity history.

3. The system of claim 1, further comprising instructions to:
present a user interface to a display device;
generate, for display in the user interface, a plurality of user interface elements, wherein the user interface elements represent activities to be completed;
receive a selection of one or more of the plurality of the user interface elements;
generate an activity matrix based on the selection;
identify completion of the activities that correspond to the activity matrix; and
modify the fee tier data structure based on the completion of the activities.

4. The system of claim 1, further comprising instructions to:
generate an activity roadmap for an entity that corresponds to the user account;
present the activity roadmap in a user interface;
identify completion of an activity that corresponds to the activity roadmap; and
modify the fee tier data structure based on the completion of the activity.

5. The system of claim 1, further comprising instructions to:
present a user interface to a display device;
generate, for display in the user interface, an editable maximum tier user interface element;
identify a modification to the editable maximum tier user interface element, wherein the modification represents a maximum fee tier;
determine that the fee tier is above the maximum fee tier; and
prevent transactions from being processed for the user account.

6. The system of claim 1, further comprising instructions to:
identify a set of features applied to the user account;
select a feature of the set of features based on the fee tier; and
remove the feature from the set of features.

7. The system of claim 1, further comprising instructions to:
determine a transaction trend over a second time period from transaction history data for the user account, wherein the transaction trend indicates a period of peak transaction velocity; and
identify the first period of time as a period of time in the transaction stream that corresponds to the transaction trend in the second period of time.

8. The system of claim 1, further comprising instructions to:
identify a set of transactions in the transaction stream that correspond to a payee; and
calculate a total transaction value of the set of transactions, wherein the instructions to generate the fee tier data structure include instructions to evaluate the total transaction value.

9. At least one computer readable storage medium including instructions for dynamic micropayment fee selection that, when executed by at least one processor, cause the at least one processor to perform operations to:
obtain a transaction stream from an electronic transaction processing service;
calculate a transaction velocity of a set of transactions that corresponds to a user account of the electronic transaction processing service included in the transaction stream for a first period of time;
generate a fee tier data structure based on the transaction velocity;
apply a fee tier of the fee tier data structure to the user account; and
transmit, to a device associated with the user account, an indication of the applied fee tier and an electronic representation of the fee tier data structure.

10. The at least one computer readable storage medium of claim 9, further comprising instructions to:
identify an activity history for the user account, wherein the activity history includes activities by an entity that corresponds to the user account outside the electronic transaction processing service, and wherein the instructions to generate the fee tier data structure include instructions to use data included in the activity history.

11. The at least one computer readable storage medium of claim 9, further comprising instructions to:
present a user interface to a display device;
generate, for display in the user interface, a plurality of user interface elements, wherein the user interface elements represent activities to be completed;
receive a selection of one or more of the plurality of the user interface elements;
generate an activity matrix based on the selection;
identify completion of the activities that correspond to the activity matrix; and
modify the fee tier data structure based on the completion of the activities.

12. The at least one computer readable storage medium of claim 9, further comprising instructions to:
generate an activity roadmap for an entity that corresponds to the user account;
present the activity roadmap in a user interface;
identify completion of an activity that corresponds to the activity roadmap; and
modify the fee tier data structure based on the completion of the activity.

13. The at least one computer readable storage medium of claim 9, further comprising instructions to:
present a user interface to a display device;
generate, for display in the user interface, an editable maximum tier user interface element;
identify a modification to the editable maximum tier user interface element, wherein the modification represents a maximum fee tier;
determine that the fee tier is above the maximum fee tier; and
prevent transactions from being processed for the user account.

14. The at least one computer readable storage medium of claim 9, further comprising instructions to:
identify a set of features applied to the user account;
select a feature of the set of features based on the fee tier; and
remove the feature from the set of features.

15. The at least one computer readable storage medium of claim 9, further comprising instructions to:
determine a transaction trend over a second time period from transaction history data for the user account, wherein the transaction trend indicates a period of peak transaction velocity; and
identify the first period of time as a period of time in the transaction stream that corresponds to the transaction trend in the second period of time.

16. The at least one computer readable storage medium of claim 9, further comprising instructions to:
identify a set of transactions in the transaction stream that correspond to a payee; and
calculate a total transaction value of the set of transactions, wherein the instructions to generate the fee tier data structure include instructions to evaluate the total transaction value.

17. A method for dynamic micropayment fee selection, the method comprising:
obtaining a transaction stream from an electronic transaction processing service;
calculating, by a computing device, a transaction velocity of a set of transactions corresponding to a user account of the electronic transaction processing service included in the transaction stream for a first period of time;
generating a fee tier data structure based on the transaction velocity;
applying a fee tier of the fee tier data structure to the user account; and
transmitting, to a device associated with the user account, an indication of the applied fee tier and an electronic representation of the fee tier data structure.

18. The method of claim 17, further comprising:
identifying an activity history for the user account, wherein the activity history includes activities by an entity corresponding to the user account outside the electronic transaction processing service, and wherein generating the fee tier data structure included using data included in the activity history.

19. The method of claim 17, further comprising:
presenting a user interface, by the computing device, to a display device;
generating, for display in the user interface, a plurality of user interface elements, the user interface elements representing activities to be completed;
receiving a selection of one or more of the plurality of the user interface elements;
generating an activity matrix based on the selection;
identifying completion of the activities corresponding to the activity matrix; and
modifying the fee tier data structure based on the completion of the activities.

20. The method of claim 17, further comprising:
generating an activity roadmap for an entity corresponding to the user account;
presenting the activity roadmap, by the computing device, in a user interface;
identifying completion of an activity corresponding to the activity roadmap; and
modifying the fee tier data structure based on the completion of the activity.

21. The method of claim 17, further comprising:
presenting a user interface, by the computing device, to a display device;
generating, for display in the user interface, an editable maximum tier user interface element;
identifying a modification to the editable maximum tier user interface element, the modification representing a maximum fee tier;
determining that the fee tier is above the maximum fee tier; and
preventing transaction processing for the user account.

22. The method of claim 17, further comprising:
identifying a set of features applied to the user account;
selecting a feature of the set of features based on the fee tier; and
removing the feature from the set of features.

23. The method of claim 17, further comprising:
determining a transaction trend over a second time period from transaction history data for the user account, wherein the transaction trend indicates a period of peak transaction velocity; and
identifying the first period of time as a period of time in the transaction stream corresponding to the transaction trend in the second period of time.

24. The method of claim 17, further comprising:
identifying a set of transactions in the transaction stream corresponding to a payee; and
calculating a total transaction value of the set of transactions, wherein generating the fee tier data structure includes evaluating the total transaction value.
